(19) United States
(12) Patent Application Publication
(10) Pub. No.: US 2026/0243125 A1
(43) Pub. Date: Aug. 20, 2026

(54) DOOR SYSTEM AND MODULE THEREFOR

(71) Applicant: Y. STERN ENGINEERING (1989) LTD., Yavne (IL)

(72) Inventors: Yuval STERN, Ramot Meir (IL); Yosef STERN, Bitzaron (IL)

(21) Appl. No.: 19/164,359

(22) PCT Filed: Mar. 12, 2024
(86) PCT No.: PCT/IL2024/050265

§ 371 Date: Sep. 11, 2025

Related U.S. Application Data
(60) Provisional application No. 63/451,598, filed on Mar. 12, 2023.

(51) Int. Cl. E05F 15/73

(52) U.S. Cl. CPC E05F 15/73; E05F 2015/765

(57) ABSTRACT

A door system comprising a door controllably shiftable between open and closed states, at least one outside sensor for sensing presence of an individual in an outside space with respect to the door, at least one inside sensor for sensing presence of an individual in an inside space with respect to the door, at least one doorway sensor for sensing presence in a passage closeable by the door, and a control unit for shifting the door between the open and closed states based on an indication received from at least one of said sensors.

### TECHNOLOGICAL FIELD

The present disclosure is concerned with a door system. More particularly the disclosure relates to an automated door system, suited for hands-free operation.

### BACKGROUND

This section intends to provide background information concerning the present application, which is not necessarily prior art.

Touchless automated door systems are gradually adopted to provide a hand-free access to closeable environment/rooms, such as, but not limited to, bathrooms, restrooms meeting rooms, and suchlike. However, the touchless automated door systems usually can be easily manipulated to falsely switch into a closed-locked state without getting the environment/room closed by the door system really occupied by anyone i.e., the touchless automated door system is falsely manipulated into the closed and locked state while being empty, and/or without being really entered by an individual.

International Patent Publication No. WO 2022/098387 discloses a touchless stall door opening and closing system that includes a motor, a door pivot for pivoting a door between an open position and a closed position, a locking mechanism for locking the door when the door is in the closed position, and a microcontroller for receiving a signal from a first sensor to drive the motor for opening the door and for receiving a signal from a second sensor for actuating the locking mechanism for unlocking the door. A method for touchless operation of the door includes touchless opening of the door, touchless closing of the door, and touchless locking and unlocking of the door.

### GENERAL DESCRIPTION

In a broad aspect there is a door system comprising a door controllably shiftable between open and closed states, an outside sensor for sensing presence in an outside space with respect to the door, an inside sensor for sensing presence in an inside space with respect to the door, a doorway sensor for sensing presence in a passage closeable by the door, and a control unit for shifting the door between the open and closed states based on indications received from the sensors. In some embodiments the door system comprises a door frame and a door (e.g., a slab/hinged door, any type of sliding door, a rotating/revolving door, or suchlike) articulated to the door frame, and a door module comprising a door motor assembly, a door locking assembly (e.g., utilizing a dead bolt or latch bolt), and a control unit. Optionally, but in some embodiments preferably, the door locking assembly, the outside sensor, the inside sensor, the doorway sensor, and the control unit, are implemented as unitary component installable either in/on the door or in/on the door's frame. The door system can comprise and/or be connectable to a suitable power source for carrying out all its functions and actions.

In possible embodiments, the outside sensor is used for generation of a door open signal, for opening the door by a motor assembly, in response to thereby sensing an individual approaching the door from the outside space, and the inside sensor is thereafter used for generation of a door close signal, for closing the door by the motor assembly, in response to thereby sensing of the individual entering the inside space. The inside sensor is further used to generate a door open signal, for opening the door by the motor assembly when in a closed state, in response to thereby sensing the individual approaching the door from the inside space.

The doorway sensor can be used to confirm generation of the door close signal, verify if there is an obstacle in the doorway, and utilized in some embodiments to prevent false door closure and lock situation and/or false occupied indications (also referred to herein as occupied indicia) i.e., the doorway sensor can be used to interlock the signals generated by the inside sensor so as to prevent door closed and locked states without the internal space being really entered by an individual). The doorway sensor is also used in some embodiments to verify door opened and/or closed states during the system operation.

The disclosed embodiments provide an individual access to a confined space fitted with a door system or a (e.g., touchless) door module, according to the disclosure hereof, without having to touch any element thereof, such as a door handle, door knob, door lock, door's surfaces etc. The door can be opened upon outside (e.g., touchless) sensor activation by the individual, closed and/or locked behind the individual upon inside sensor activation, and the door can be thereafter opened upon demand upon inside (e.g., touchless) sensor activation by the individual. The doorway sensor can be used to prevent generation of false door open and/or door close and door lock signals based on presence/absence of indications therefrom in the transition from an opened state to a closed state of the door.

This touchless access control arrangement is thus useful in preventing, or reducing to minimum, the possible contamination that may be otherwise transferred between individuals upon touching commonly used elements. A door entrance fitted with a door system according to the present disclosure can thus facilitates an individual to open a door for entry into a confined space, then have the door close and/or locked behind her when within the confined space, and have the door open again, at demand, for the individual to exit the confined space e.g., all of which can take place automatically without having to touch any portion of the door system. The door system is configured for indicating an actual situation of the door system and optionally there is an override mechanism for manipulating the system.

The door system comprises at least one (e.g., touchless) inside sensor for sensing an entrance approach to the door frame/system and/or occupation of an inside environment/space by one or more persons. An entrance signal generated by the control unit includes in some embodiments a signal received from the at least one inside sensor e.g., resulting in generating door close and door lock signals and/or an occupied indicia. An exit indicia generated by the control unit can also include a signal received from the at least one inside sensor indicative of an intention to exit the inside environment/space via the door e.g., resulting in generating a door open signal.

The control unit comprises in possible embodiments a signaling module used for generating the door open, door close, and door lock, control signals and/or noticeable door mode (e.g., audio and/or visible) indicia responsive to door parameters e.g., displayed at either or both of an outside and an inside of the door. For example, the door mode indicia can be a type of light emitting signal displayable at a door handle height e.g., providing alert indicia while displacing between respective open position and closed position. The door mode indicia and/or parameters can include indications relating to one or more of the following indications: door is open; door is closed, locking assembly is locked, locking assembly is unlocked, door closed but unlocked, locking bolt disturbed, door motor disturbed, confined/internal space is occupied, power source fault, communication fault, system malfunction, service required, access denied, number of use sequences, door system has been used a predetermined number of times. The door mode indicia can be integrated with the control unit, sensors, and door locking mechanism, to form a unified door module installable either in/on the door or the door stile.

In some embodiments the door system comprises at least one (e.g., touchless) outside sensor for sensing an entrance approach to the door frame/system. An entrance state can be issued by the control unit in some embodiments upon receipt of a first signal from the at least one outside sensor, and a sequential receipt of a second signal from the at least one inside sensor e.g., resulting in generating a door close signal and/or an occupied indication. Alternatively, the entrance state can be issued by the control unit upon receipt of a first signal from the at least one outside sensor, a sequential receipt of a second signal from the at least one doorway sensor, and thereafter receipt of a third signal from the at least one inside sensor e.g., resulting in generating door close and door lock signals and/or an occupied indication.

Optionally, but is some embodiments preferably, the control unit requires inactivation of the first and/or second signals from the at least one outside sensor and/or the at least one doorway sensor before generating the door close and door lock signals, and/or the occupied indication, based on the third signal from the at least one inside sensor. For example, if the third signal is received from the at least one inside sensor concurrently while the first and/or second signal are being received from the outside and/or doorway sensor, the control unit will not generate the door close signal, and/or the occupied indication.

In possible embodiments, if the third signal is received from the at least one inside sensor concurrently while the first and/or second signals are being received from the outside and/or doorway sensor, the control unit generates only the door close signal for closing the door, without generating the door lock signal and/or issuing the occupied indication i.e., to just close the door. Optionally, if this faulty state persists (i.e., there is no inactivation/extinguish of the signals from the outside and/or the doorway sensors while signal is received from the inside sensor) for a predefined time period, the control unit can generate a malfunction indicia. In case such faulty state is repeatedly occurring a predefined number of time (e.g., 3 to 5) the control unit can generate an access denied indicia for a predetermined time interval (e.g., 3 to minutes, or more), so as to prevent access of individuals attempting to tamper with the door system.

The sensors of embodiments hereof can be configured to generate indications responsive to presence of an object/individual in their vicinity, and to stop generating the indication (also referred to herein as inactivation/extinguish of the signal from the sensor) when the object/individual in moved from their vicinity. In the following description receipt of a signal from a sensor is sometimes indicated by an upwardly directed arrow e.g., “inside sensor ↑” means an indication is received from the at least one inside sensor, and the extinguish of the signal from the sensor is sometimes indicated by a downwardly directed arrow e.g., “inside sensor ↓” means that indication from the at least one inside sensor is extinguished or not received.

In one aspect there is a door system comprising a door controllably shiftable between open and closed states, the door system comprising at least one outside sensor for sensing presence in an outside space with respect to the door, at least one inside sensor for sensing presence in an inside space with respect to the door, at least one doorway sensor for sensing presence in a passage closeable by the door, and a control unit for shifting the door between the open and closed states based on indications received from at least one of the sensors. Optionally, but in some embodiments preferably, the at least one outside sensor, the at least one inside sensor, the at least one doorway sensor, and the control unit, are part of a unitary component installable either in/on the door or its frame.

The door system can be configured to detect entrance of an individual into the inside space based on consecutive rise and fall of a signal generated by the at least one doorway sensor. For example, the time interval between the consecutive rise and fall of the signal from the at least one doorway sensor can be in the range of 0.2 to 5 seconds.

The control unit can be configured to generate a door close signal and/or a door lock signal for changing the door into the closed state and/or locking it when a signal is received from the at least one inside sensor and there is no signal from the at least one doorway sensor. The door system can be configured to issue the door close signal and/or the door lock signal if a time condition between a fall of a signal from the at least one doorway sensor and a rise of a signal from the at least one inside sensor is satisfied. For example, the time condition between the fall of the signal from the at least one doorway sensor and the rise of the signal from the at least one inside sensor can be in a range of 0.2 to 7 seconds. In possible embodiment the system is configured to issue the door close signal if the time condition between the fall of the signal from the at least one doorway sensor and the rise of the signal from the at least one inside sensor is not satisfied, for closing the door without locking it.

The control unit can issue an occupied indicia (i.e., occupied state) after generating the door close signal and/or the door lock signal, and optionally also after receiving a signal from the at least one doorway sensor indicative of closure of the door.

The door system can be configured to generate a door open signal for changing the door into the open state when an occupied indication is generated and a signal is received from the at least one inside sensor. In some embodiments the door system is configured to inactivate an occupied indication after issuing the door open signal and detecting based on signals from the doorway sensor that the door changed into the open state and/or passage of the individual from the inside space to the outside space.

The door system can be configured to generate a door open signal for changing the door into the open state when the occupied indicia/state is not generated, signal from the at least one doorway sensor is indicative of the door being in a closed states, and a signal is received from the at least one inside sensor. The door can be a type of hinged door, sliding door, or rotating door.

In some embodiments the sensors and control unit are part of a unitary component installable either in/on the door or in/on a door stile of said door. The unitary component can further comprise a door lock mechanism. Optionally, at least one of the sensors is a proximity sensor. Optionally, at least the at least one doorway sensor is an optical sensor.

According to another aspect of the disclosure there is disclosed a (e.g., touchless) door module for use with a door system comprising a door frame and a door articulated to the door frame. The (e.g., touchless) door module comprising in some embodiments a door locking assembly and a control assembly for operating a door motor assembly utilizing the inside, doorway and inside, sensors. Optionally, but in some embodiments preferably, the door locking assembly, control assembly and its sensors, are integrated in a unitary component installable either in/on the door or its frame.

The touchless door module can comprise and/or connectable to a suitable power source for carrying out all its functions and actions.

The door motor assembly is configured for displacing the door between an open position and a closed position e.g., responsive to a door open signal or a door close signal, respectively, generated by the control unit/signaling module.

The locking assembly can be configured for displacing a locking bolt between a locked position at which it is engageable with a locking strike e.g., responsive to a locking signal emitted from the control unit, and an unlocked position e.g., responsive to an unlocking signal emitted from the control unit, or responsive to inactivation of the locking signal. The locking strike can be integral with, or integrated with, a lock stile of the door or with a lock jamb of the door frame. Optionally, the unlocking signal can be configured to distinguish authorization for entry into the confined space to particular individuals or groups.

The control unit comprises in some embodiments a signaling module configured for emitting noticeable door mode indicia e.g., responsive to door parameters.

The door can be fitted to admit touchless access into any confined space, at any site, such as a toilet cabin, a bathroom, a clean room of any type, etc.

The door system and the (e.g., touchless) door module according to the present disclosure can be configured for retrofit in existing locations, by replacing the entire door and/or frame, or by replacing only selected components of the door system.

Touchless sensors can be one or more sensors that do not require actual users' contact therewith, and configured for emitting a signal responsive to an external signal picked-up e.g., proximity sensors such as an infrared (IR e.g., active or passive) sensor, an RFID sensor, an NFC sensor, a magnetic sensor, an optical/light sensor, an image-recognition sensor (e.g., face recognition), an ultrasonic sensor, a voice/sound recognition sensor, etc. In possible embodiments one or more touch-sensors/tactile-sensors are used in addition to, or instead of, the one or more touchless sensors. For example, a type of press button, resistive, keypad, inductive or capacitive, touch-sensor can be used instead of, or in addition to, the outside sensor and/or the inside sensor.

The door system and (e.g., touchless) door module can further comprise at least one door position sensor e.g., the locking signal can be generated upon sensing a closed position generated by the at least one door position sensor. The communication between the door system components can be through wireless communication or over electric wiring (e.g., over serial and/or parallel data communication bus) extending between the respective system components. For example, the door system can further comprise a communication module configured for transmitting data wirelessly (or over bus lines) regarding door parameters to a remote location. The control unit can generate a communication fault indicia whenever it is thereby determined that data/signal communication cannot be performed by the communication module.

The locking assembly can comprise a manual override mechanism, configured for manipulating the locking assembly between its respective positions e.g., the manual override mechanism can be configured at any one or both of the inside and outside of the door assembly i.e., the manual override mechanism can be accessible for manual manipulation from an inside and/or an outside of the door system;

The door motor assembly can be disposed at either an inside or an outside of the door, and/or fitted within the door or within the door frame. For example, the door motor (e.g., electric motor, a hydraulic or a pneumatic motor, or suchlike) assembly can comprise a motor unit fixed to one of the door and the frame, with a respective manipulating member extending from the motor unit to the other one of the door and the frame. In some embodiments the door motor assembly comprises a clutch mechanism configured to discontinue displacing the door between its respective position at the event of an obstacle disposed at the door's path of displacement. Optionally, one or more sensing elements are used for determining motor position and transmitting motor indicia to the control unit.

The locking assembly, and/or the control unit, can be configured at the lock jamb or at the lock stile, and they can be integral or separated from one another. Optionally, but in some embodiments preferably, the locking assembly, the control unit and all sensor elements of the systems, are integrated in a unitary (e.g., touchless) door module e.g., fitted in a lock jamb of the door system.

The door assembly can be configured with a fee charging module i.e., the door will open conditional to fee transmittal. Fee transmittal of the fee charging module can be collected by a site payment (e.g., coins, notes, NFC transfer, credit card payment, etc.) or by a pre-paid arrangement.

The door system can be configured such that at a standby position i.e., when the confined/internal space is in unoccupied state, the door is in a normally closed, or a normally open, state. For example, at a normally standby position the door can be at a closed, unlocked position, at the normally standby position the door motor assembly can be disconnected, so as to facilitate opening the door manually, and/or when the door is closed at a standby position the locking assembly can be locked. At a service position the door can be disposed at the closed and locked position e.g., unlocking the locking assembly can be facilitated for authorized individuals.

The door system can be configured with an external knob e.g., comprising one or all of the sensors and an outside door mode signal emitting system. Optionally, the door system comprises an occupied sensor (e.g., at an inside face of the door) configured to sense the presence of an individual within the confined space, and generate a respective occupied indicia. The control unit can be accordingly configured maintain a closed state of the door as long as an occupied signal is thereby received. In possible embodiments a timer is utilized to generate a door closing signal for closing the door after a predetermined time has lapsed from a proceeding signal. The timer can be configured for closing the door after a predetermined time has lapsed from receiving a signal from an inside sensor. Additionally, or alternatively, the timer can be configured for closing the door after a predetermined time has lapsed from issue of a signal indicating that the door has opened. Additionally, or alternatively, the timer can be configured for issuing the door close signal if the time between extinguish of signal from a doorway sensor and receipt of a signal from an inside sensor is greater than some predetermined allowable time interval e.g., greater than 1, 2, 3, 4 or 5 seconds.

The door system can be configured to use one or more biometric sensors instead of, or in addition, to the outside, doorway, and/or the inside sensor. Optionally, the door system comprising a fingerprint scanner and/or a face recognition sensor (e.g., utilizing a camera and face recognition software). Optionally, the door system comprises one or more touch-sensors (e.g., press-button, resistive or capacitive/inductive sensor, keypad) instead of, or in addition, to the outside, doorway, and/or the inside sensor.

In another aspect there is a method of operating a door system configured to controllably change a door between open, closed and/or locked, states thereof. The method comprising receiving signal from a doorway sensor indicative of presence of an individual in a passage closeable by the door followed by signal from an inside sensor indicative of presence of an individual in an inside space with respect to the door, and responsively issuing a door close and/or door lock signal for causing closure and/or locking of the door. The method can comprise detecting fall of the signal from the doorway sensor before rise of the signal from the inside sensor, before issuing the door close and/or the door lock signal.

The method comprising in some embodiments issuing the door close signal if a predefined time interval has lapsed between the fall of the signal from the doorway sensor and the rise of the signal from the inside sensor. The method can comprise issuing only a door close signal if the predefined time interval did not lapse between the fall of the signal from the doorway sensor and the rise of the signal from the inside sensor, for closing the door without locking it.

In some embodiments the method comprises issuing an occupied indication after issuing the door close and/or door lock signals. The method can comprise receiving signal from the doorway sensor indicative that the door is in the closed state before generating the occupied indication. In a variant the method comprises receiving signal from the inside sensor after the occupied indication is generated, and responsively issuing a door open signal for changing the door into the open state, and stopping generation of the occupied indication.

Optionally, the method comprises receiving signal from an outside sensor indicative of presence of an individual in an outside space with respect to the door and issuing a door open signal if an occupied indication is not being generated. The method can comprise receiving signal from the doorway sensor indicative that the door is in the closed state before issuing the door open signal.

The door system can be configured in accordance with any of the embodiments of the door system and/or modules disclosed and illustrated in International Patent Publication No. WO 2021/255732, of the same applicant hereof, the disclosure of which is incorporated herein by reference.

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings like reference numerals are used to indicate corresponding parts, and in which:

FIG. 1 schematically illustrates a door way system according to some possible embodiments;

FIGS. 2A and 2B schematically illustrate a top view of the door way system according to some possible embodiments, without the door rail, wherein FIG. 2A exemplifies use of a proximity doorway sensor and FIG. 2B exemplifies use of an optical doorway sensor;

FIGS. 3A and 3B schematically illustrate components of the control assembly according to some possible embodiments of slab/hinged and slidable door configurations, respectively;

FIGS. 4A and 4B schematically illustrate functionality of a signaling module according to some possible embodiments; and

FIG. 5 is a flowchart demonstrating possible automated door system operation according to possible embodiments.

### DETAILED DESCRIPTION OF EMBODIMENTS

One or more specific and/or alternative embodiments of the present disclosure will be described below with reference to the drawings, which are to be considered in all aspects as illustrative only and not restrictive in any manner. It shall be apparent to one skilled in the art that these embodiments may be practiced without such specific details. In an effort to provide a concise description of these embodiments, not all features or details of an actual implementation are described at length in the specification. Elements illustrated in the drawings are not necessarily to scale, or in correct proportional relationships, which are not critical. Emphasis instead being placed upon clearly illustrating the principles of the invention such that persons skilled in the art will be able to make and use the door system, once they understand the principles of the subject matter disclosed herein. This invention may be provided in other specific forms and embodiments without departing from the essential characteristics described herein.

The present application provides a door system comprising a motor activated door, and sensor and control units configured for (e.g., touchless) opening and closing the door, and to prevent occurrence of faulty door closure and lock situations and/or faulty occupied indications. This is achieved in some embodiments utilizing at least one outside sensor for issue of door open signals, at least one inside sensor for issue of door close and door lock signals, and a doorway sensor for detecting presence of a user, obstructions and/or of the door, in the doorway, during the system's operation.

The doorway sensor can be used to verify passage of an individual from the outside space with respect to the door to the inside space with respect to the door e.g., by detecting the following sequence of sensor's activation/inactivation: doorway sensor↑→doorway sensor↓→inside sensor↑. The control unit can be configured to issue the door close and the door lock signals after detection of the sequence of sensor's activation/inactivation. Optionally, but in some embodiments preferably, the control unit is configured to issue the door close and the door lock signals if the time lapsed between the fall of the signal from the doorway sensor (↓) and the rise of the signal from the inside sensor (↑) is greater than some predetermined time interval e.g., 0.2 to 7 seconds, or alternatively 0.5 to 5 second, optionally about 0.5 to 3 seconds or 1 to 3 seconds.

For an overview of several example features, process stages, and principles of the invention, the door system examples illustrated schematically and diagrammatically in the figures are intended for a restroom (e.g., toilet/lavatory). These door systems are shown as one example implementation that demonstrates a number of features, processes, and principles used to provide a touchless automatic door system, but they are also useful for other applications and can be made in different variations. Therefore, this description will proceed with reference to the shown examples, but with the understanding that the invention recited in the claims below can also be implemented in myriad other ways, once the principles are understood from the descriptions, explanations, and drawings herein. All such variations, as well as any other modifications apparent to one of ordinary skill in the art and useful in door system applications may be suitably employed, and are intended to fall within the scope of this disclosure.

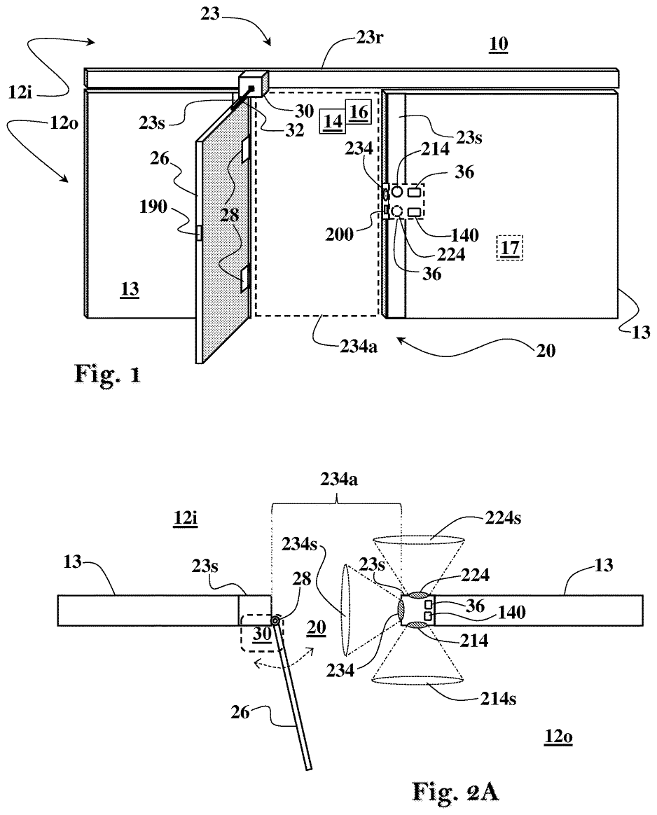

Attention is first directed to FIG. 1 of the drawings schematically illustrating a doorway generally designated 10, defining a passage 234a between an internal space 12i e.g., accommodating a toilet 14 and a sink 16, and an outer space 120 e.g., utilizing an outwardly open slab door system (also known as a hinged door).

In this specific and non-limiting example, the door system 20 comprises a door frame 23 and a door 26 hingedly articulated to the frame 23 by one or more hinges 28, a door motor assembly 30 mounted to the door frame 23 (e.g., to the door rail 23r, internally or externally) and articulated to the door 26 via a lever 32. Alternatively, the door motor assembly 30 can be mounted to the door 26 and articulated to the door frame 23 via the lever 32. A door locking assembly (utilizing a lock-strike 200 and a lock-jamb 190) with an integrated control assembly generally designated 36 is fitted within the door frame 23 (in the door stile 23s e.g., at a lock stile thereof) and/or the wall 13 partitioning between the internal and outer spaces 12i and 120. Alternatively, the door locking assembly and its control assembly 36 can be similarly fitted within the door 26 (e.g., at a lock stile thereof). A power source 17 e.g., extending within the walls 13, is utilized for supplying electric power to the door motor assembly 30, the integrated door locking assembly and the control assembly 36.

It is appreciated that the door system 20 can be an entrance port to any type of confined space e.g., where hygiene and/or admittance control are required.

In general, the door motor assembly 30 opens the door 26 in response to a door open (open) signal, closes the door 26 in response to a door close (close) signal from the control assembly 36, and locks the door 26 in response to a door lock signal from the control assembly 36 e.g., the signaling can be transferred by wire or wireless communication, such as, but not limited to, Bluetooth communication, RF communication etc. The door motor assembly 30 can be configured with a position sensor (not shown) for determining motor position (e.g., angular position) and transmitting motor indicia to the control assembly 36.

The control assembly 36 comprises an outside sensor 214 for (e.g., touchless) sensing nearby presence in the outer space 12o, an inside sensor 224, for (e.g., touchless) sensing nearby presence in the internal space 12o, and a doorway sensor 234, for (e.g., touchless) sensing nearby presence within the doorway passage 234a. A control unit 36c of the control assembly 36 is configured to receive presence signal indications from the various sensors and generate based thereon the door open, door close and/or door lock signals for operating the door motor assembly 30 and/or the door locking assembly, and other possible signals and/or indications, as described hereinabove or hereinbelow.

In some embodiments one or more of the presence sensors are implemented by a type of touchless sensors, such as an optical/IR sensor, an RFID sensor, an NFC sensor, a magnetic sensor, an optical/light sensor, an image-recognition sensor (e.g., face recognition), an ultrasonic sensor, a voice/sound recognition sensor, or any type of biometric sensor etc. Optionally, at least one of the inside and/or the outside sensors is implemented with a keypad and/or a card reader unit, for permitting access to authorized users only having a secret code and/or a personal authentication card, and/or to override system settings by administrator e.g., for maintenance and/or malfunctions.

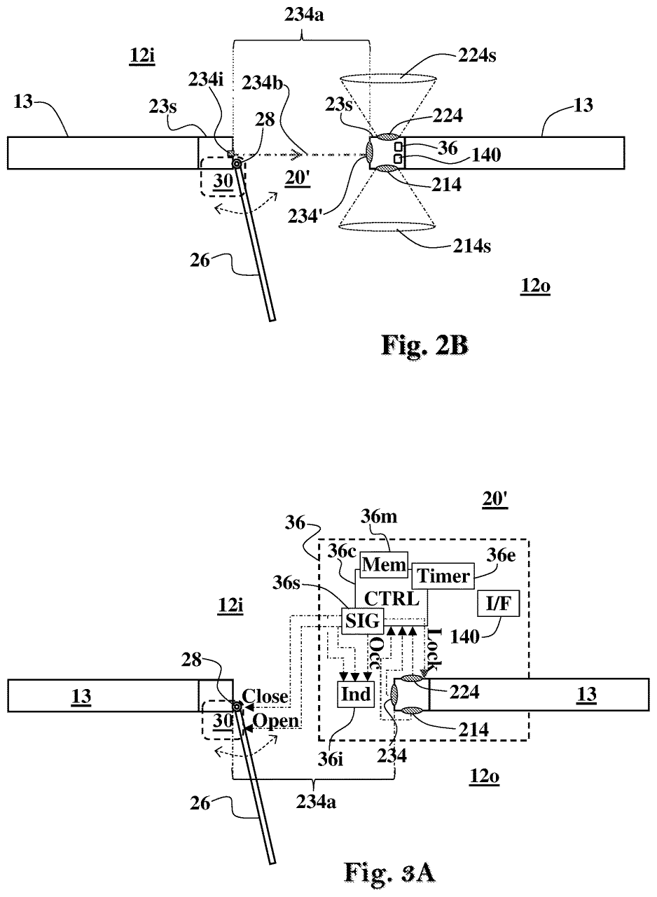

As exemplified in FIG. 2A, the outside sensor 214 can be accordingly configured to generate an outside signal to the control assembly 36 e.g., responsive to an individual approaching or in the vicinity of the outside sensor 214 and entering a detection region 214s thereby defined in the outside space 12o (i.e., touching is not required). The inside sensor 224 can be accordingly configured to generate an inside signal to the control assembly 36 upon sensing an individual approaching or in the vicinity of the inside sensor 224 and entering a detection region 224s thereby defined in the inside space 12i (i.e., touching is not required). The doorway sensor 234 can be accordingly configured to generate a doorway signal to the control assembly 36 upon sensing an individual entering a detection region 234s thereby defined within the doorway passage 234a. Accordingly, in this configuration the doorway sensor 224 can also generate the doorway signal to the control assembly 36 when the door 26 is displaced into a closed state and at least partially positioned in the detection region 234s of the doorway sensor 224.

FIG. 2B shows a possible embodiment of the door system 20′ in which the doorway sensor 234′ is implemented by an optical sensor configured to detect presence of an individual, an object, or the door 26, in the doorway passage 234a. For example, the doorway optical sensor 234′ can be configured to detect a light beam 234b in the doorway passage 234a. In this configuration, if an individual, object, or the door 26, is present in the doorway passage 234a the propagation of the light beam 234b will be stopped and prevented from reaching the optical sensor 234′.

A light source 234i can be configured in/on the door stile 23s opposite to the doorway optical sensor 234′ for continuous emission of the light beam 234b towards the doorway optical sensor 234′. In possible embodiments the door system can be configured to use both a proximity doorway sensor 234 and an optical doorway sensor 234′ to detect an individual, object, or the door 26, in the doorway passage 234a.

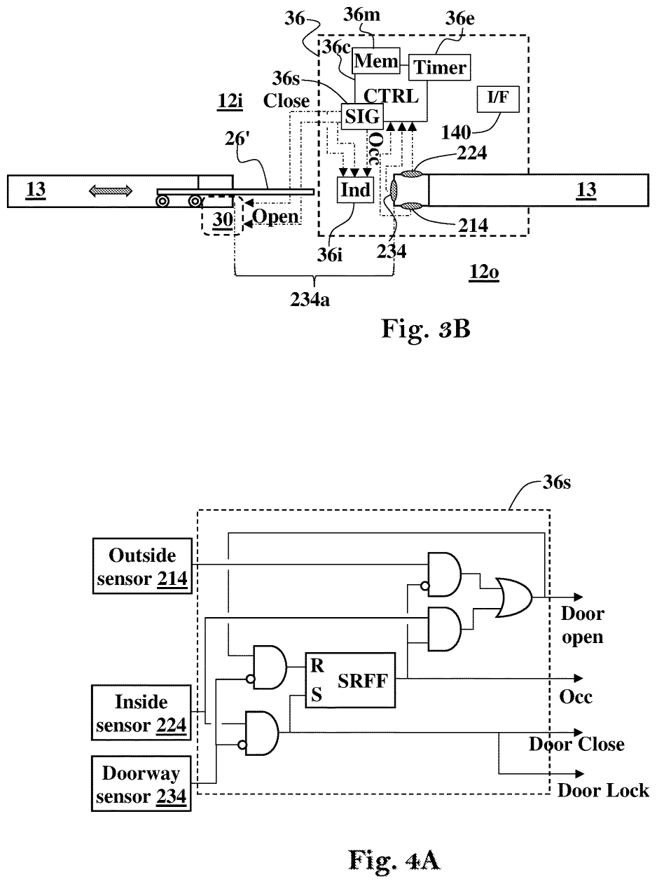

FIG. 3A exemplifies a control assembly 36 according to some possible embodiments comprising a control unit 36c, a signaling module 36s, an indicia module (Ind) 36i, and the various sensor elements. As seen, the control unit 36c is configured to receive the outside signal from the outside sensor 214, the doorway signal from the doorway sensor 234, the inside signal from the inside sensor 224, and generate based thereon a door close signal, a door open signal, door lock signal, and/or various indications for individuals' attention. The door motor assembly 30 is configured to open the door 26 upon receipt of the door open signal, and to close the door 26 upon receipt of the door close signal, and locking mechanism is configured to lock the door upon receipt of the door lock signal. Optionally, but in some embodiments preferably, the various signals and/or indications are generated by the signaling module 36s, and presented by the indicia module 36i.

The control assembly 36 can be configured to communicate with the door motor assembly 30, and/or the door lock mechanism, either by wire or wireless communication. In addition, the control assembly 36 can comprise various features such as a communication interface (I/F) module 140 for transferring data regarding door parameters e.g., to a remote location, such as, but not limited to, a service center or a service person. The doorway sensor 234 can be configured for generating the doorway signal indicative of an obstruction within the passage 234a of the door. The control assembly 36 can be configured with other control and sensing features. Optionally, one or more timers 36e are used in the control assembly 36. The control assembly 36 can be configured to use the timer(s) 36e for generating one or more of its signals, such as lock/unlock/door open/door close after a predetermined time has lapsed from a previously picked up command or signal.

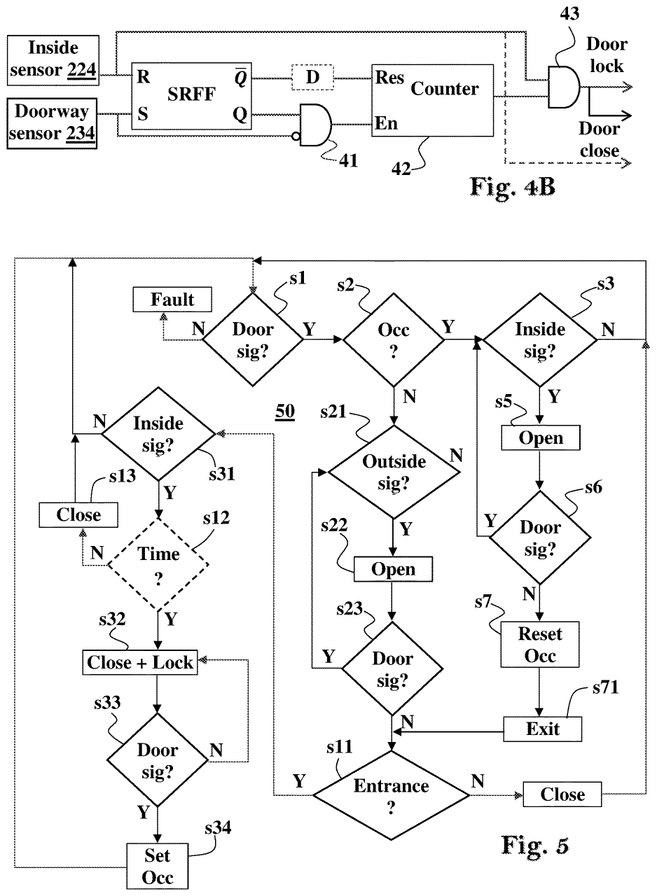

FIG. 4A demonstrates a signaling module 36s according to possible embodiments. In this specific and non-limiting example the door close and door lock signals are generated when the inside signal indication is generated by the inside sensor 224 conditioned in that there is no doorway signal indication from the doorway sensor 234 (inside sensor and doorway sensor↓ i.e., indicating that the door 26 is in an open state and there are no obstructions in the doorway passage 234a). This mechanism can effectively prevent false door closure and lock by individuals pretending to pass through the doorway passage 234a without actually doing so (i.e., causing generation of the inside signal from the outside space 12o e.g., by introducing their hand, leg, or other body part or object, through the doorway from the outside space 120 into the internal space 12i to cause generation of the inside signal by the inside signal sensor 224 without actually passing through the doorway passage 234a).

As also seen, the signaling module 36s can be configured to issue an occupied (Occ) indicia/state responsive to the door close and doo lock signals. In this specific and non-limiting example the Occ indication is issued by a set-reset flip flop (SRFF) configured to latch the door close and door lock signals inputted on its set(S) input, and continuously output the Occ indication thereafter (also referred to as Occ active indication), until a reset signal is received on its reset (R) input, which inactivates the Occ indicia/state.

In addition, the signaling module 36s can be configured to generate the door open signal whenever the Occ indication is active (i.e., “ON”—the inside space 12i is occupied) and an inside signal is generated by the inside sensor 224 (Occ↑ and inside sensor↑), or whenever the Occ indication is inactive (i.e., “OFF”—the inside space 12i is not occupied) and an outside signal is generated by the outside sensor 214 (Occ↓) and outside sensor↑). In possible embodiments, the SRFF reset signal is generated when the door open signal is generated by the signaling module 36s conditioned in that there is no doorway signal indication from the doorway sensor 234 (door open↑ and doorway sensor↓ i.e., which confirms that the door 26 indeed changed into an open state).

The signaling module 36s can be implemented in different ways, other than exemplified in FIG. 4A, by hardware and/or program code carried out by the control unit 36c. FIG. 4B exemplifies a possible implementation of the door close and door lock signaling utilizing a timer (e.g., counter) 42 to issue of the door close and door lock signals only if a predefined time interval lapsed between extinguish of the doorway sensor signal and the receipt of the inside sensor signal. In this non-limiting example a set-reset flipflop (SRFF) is used to latch a rise of the doorway sensor (1), which will change its “Q” output into the ON state. The logical AND gate 41 is configured to enable the counter 42 when the “Q” output of the SRFF is in the ON state and the extinguish of the doorway sensor (↓) is detected. The logical AND gate 43 is configured to issue the door close and door lock signals if a rise of the inside sensor (↑) signal is detected after the counter 42 carried a predefined count (i.e., a predefined time interval lapsed) since the extinguish of the signal indication from the doorway sensor 234, which typically will be also followed by generation of the occupied indica/state.

If the a rise of the inside sensor (↑) signal is detected before the counter 42 carried its predefined count the SRFF and the counter 42 will be reset, and a door close signal will not be issued. It is assumed that the delay time required for the reset of the SRFF and counter 42 to propagate to the logical AND gate 43 is sufficient for generation of the door close signal, or that an optional delay time unit (D) is used somewhere therealong to guarantee that it is timely issued. Optionally, but in some embodiments preferably, the rise of the inside signal from the inside sensor 224 without the count indication form the counter 42 (i.e., the predefined time interval between the fall/extinguish of the doorway sensor 234 and the rise of the inside sensor 224 did not lapse) will cause the control unit 36c to issue only the door close signal, for closing the door without locking it (i.e., also without generating the occupied indicia/state).

FIG. 5 is a flowchart schematically illustrating a door system operation process 50 according to some possible embodiments. In this non-limiting example a door open signal can be generated (s22) when the doorway signal (↑) is generated by the doorway sensor 234 (s1 i.e., the door 26 is in a closed state), the Occ indicia/state is inactive (↓) (s2 i.e., the inside space 12i is not occupied), and the outside signal (↑) is generated by the outside sensor 214 (S21 i.e., an individual is entering the detection region 214s of the outside sensor 214). The loop of steps s21, s22 and s23, may be carried out repeatedly as long the doorway signal (↑) is still generated by the doorway sensor 234 (s23 i.e., the door 26 is still in the closed state). The control can be passed to step s11 once the doorway sensor 234 (↓) stops generating the doorway signal (s23 i.e., the door changed into an open state), for determining if an individual is entering the passage (234a) of the door system.

In this non-limiting example a door open signal can be also generated (s5) when the doorway signal (↑) is generated by the doorway sensor 234 (s1 i.e., the door 26 is in a closed state), the Occ indication is active (↑) (s2 i.e., the inside space 12i is occupied), and the inside signal (↑) is generated by the inside sensor 224 (s3 i.e., an individual is entering the detection region 224s of the inside sensor 224). The loop of steps s3, s5 and s6, may be carried out repeatedly as long the doorway signal (↑) is still generated by the doorway sensor 234 (s6 i.e., the door 26 is still in the closed state). Once the doorway sensor 234 (↓) stops generating the doorway signal (s6 i.e., the door changed into an open state), the Occ indication is changed into an inactive (↓) state (s7 i.e., the inside space 12i is not occupied), the individual exits the inside space (s71), and the control can be passed to step s11, for determining if an individual is entering the passage (234a) of the door system.

The exit and/or entrance detection steps (s71 and/or s11) are configured in some embodiments to determine that a user is passing through the passage 234a of the door system based on indications received from the doorway sensor 234. For example, passage through the passage 234a can be determined if consecutive rise (↑) and fall (↓) of the signal from doorway sensor 234 is detected. A timer (36e) can be used to ascertain that the time lapsed between the rise (↑) and fall (↓) of the signal from doorway sensor 234 is acceptable (e.g., between 0.2 to 5 seconds, or alternatively between 0.5 to 3 seconds, optionally about 1 to 3 seconds) for determining passage of the individual through the doorway passage 234a.

In this non-limiting example a door close and door lock signals can be generated (s32) after entrance is detected (s11), and the inside signal (↑) is generated by the inside sensor 224 (s31 i.e., an individual is entering the detection region 224s of the inside sensor 224). If rise of the inside signal from the inside sensor 224 is not detected (s31), then the state of door will remain unchanged e.g., in the open state.

Optionally, entrance into the inside space is verified (s12) by assuring that a predefined time interval has passed since the fall (↓) of the signal from doorway sensor (in step s11) and the rise of the signal (↑) from the inside sensor 224 (in step s31). If the time interval condition of step s12 is satisfied the close door and door lock signals are issued in step s32. Otherwise, in possible embodiments, if the time interval condition of step s12 is not satisfied, then only the door close signal is issued (s13) for closing the door without locking it i.e., and without generating the occupied indica/state.

The loop of steps s32 and s33 may be carried out repeatedly until the doorway signal is generated by the doorway sensor 234 (s33 i.e., as long the door 26 is still in the open state). Once the doorway signal is generated by the doorway sensor 234 (s33 i.e., the door 26 changed into a closed state), the Occ indication is changed into an active state (s34 i.e., the inside space 12i is occupied), and the control can be passed back to step s1.

The locking assembly comprises in some embodiments a manual override mechanism (not shown) e.g., accessible through an outside plate panel for manual manipulation of the locking assembly. This may be required in order to override the electric locking mechanism in case of some malfunction.

Thus, it is appreciated that opening and closing of the door 26 can be entirely touchless, and the process can be carried out merely by an array of touchless sensors, wherein the door motor assembly is configured for displacing the door between the open position and the closed position, responsive to a door open signal or a door close signal, respectively, emitted from the control assembly. For example, the locking assembly can be configured for displacing a locking bolt between a locked position at which it is engageable with a locking strike, responsive to a door lock signal emitted from the control assembly, and an unlocked position, responsive to an unlocking signal emitted from the control assembly.

The control assembly and its at least one outside sensor and/or its at least one inside sensor, can be installed at various different locations in/on the door system or elsewhere. For example, the outside sensor 214 can be installed on/in an outside surface of the door 26, or alternatively on/in an outside surface of the wall 13 partitioning between the internal and outer spaces 12i and 120, or elsewhere in the outer space 120. Similarly, the inside sensor 224 can be installed on/in an inside surface of the door 26, or alternatively on/in an inside surface of the wall 13 partitioning between the internal and outer spaces 12i and 120, or elsewhere in the inner space 12i. The doorway sensor 234 can be similarly installed in/on other locations within the passage 234a e.g., in/on the door rail 23r or the floor of the doorway.

In possible embodiments the door module can be configured with an override system (e.g., mechanical override), facilitating unlocking the locking assembly and opening the door. This can be done from the outside and optionally from the inside, and is useful for example at the event of malfunction of the system, power failure, user-related event, etc.

As described hereinabove and shown in the associated figures, the present invention provides an automated (e.g., touchless) door system for confined spaces and related methods. While particular embodiments of the invention have been described, it will be understood, however, that the invention is not limited thereto, since modifications may be made by those skilled in the art, particularly in light of the foregoing teachings. As will be appreciated by the skilled person, the invention can be carried out in a great variety of ways, employing more than one technique from those described above, all without exceeding the scope of the claims.

1. A door system comprising:
a door controllably shiftable between open and closed states,
at least one outside sensor for sensing presence of an individual in an outside space with respect to said door,
at least one inside sensor for sensing presence of an individual in an inside space with respect to said door,
at least one doorway sensor for sensing presence in a passage closeable by said door, and
a control unit for shifting said door between said open and closed states based on an indication received from at least one of said sensors.

2. The door system of claim 1 configured to generate a door close signal and/or a door lock signal for changing the door into the closed state and/or locking it when a signal is received from the at least one inside sensor and there is no signal from the doorway sensor.

3. The door system of claim 1 configured to detect entrance of an individual into the inside space based on consecutive rise and fall of a signal generated by the at least one doorway sensor.

4. The door system of claim 3 wherein the time interval between the consecutive rise and fall of the signal from the at least one doorway sensor is in the range of 0.2 to 5 seconds.

5. The door system of claim 1 configured to issue the door close signal and/or the door lock signal if a time condition between a fall of a signal from the at least one doorway sensor and a rise of a signal from the at least one inside sensor is satisfied.

6. The system of claim 5 wherein the time condition is in a range of 0.2 to 7 seconds.

7. The door system of claim 5 configured to issue the door close signal if the time condition between the fall of the signal from the at least one doorway sensor and the rise of the signal from the at least one inside sensor is not satisfied, for closing the door without locking it.

8. The door system of claim 1 configured to issue an occupied indication after generating the door close signal and/or the door lock signal and receiving a signal from the at least one doorway sensor indicative of closure of the door.

9. The door system of any claim 1 configured to generate a door open signal for changing the door into the open state when an occupied indication is generated and a signal is received from the at least one inside sensor, and/or inactivate an occupied indication after issuing the door open signal and detecting based on signals from the doorway sensor that the door changed into the open state and/or passage of the individual from the inside space to the outside space.

10. (canceled)

11. The door system of claim 1 configured to generate a door open signal for changing the door into the open state when an occupied indication is not generated, signal from the at least one doorway sensor is indicative of the door being in a closed states, and a signal is received from the at least one outside sensor.

12. The door system of claim 1 wherein the door is a hinged door or sliding door.

13. (canceled)

14. The door system of claim 1 wherein the sensors and control unit are part of a unitary component installable either in/on the door or in/on a door stile of said door; and/or the unitary component further comprises a door lock mechanism.

15. (canceled)

16. The door system of any claim 1 wherein at least one of the sensors is a proximity sensor and/or the at least one doorway sensor is an optical sensor.

17. (canceled)

18. The door system of claim 1 comprising at least one of the following: one or more biometric sensors instead of, or in addition, to the outside, doorway, and/or the inside sensor; one or more touch-sensors instead of, or in addition, to the outside, doorway, and/or the inside sensor; a fingerprint scanner and/or a face recognition sensor; and/or a keypad.

19. (canceled)

20. (canceled)

21. (canceled)

22. A method of operating a door system configured to controllably change a door between open and closed states thereof, the method comprising receiving signal from a doorway sensor indicative of presence of an individual in a passage closeable by said door followed by signal from an inside sensor indicative of presence of an individual in an inside space with respect to said door, and responsively issuing a door close and/or door lock signal for causing closure and/or locking of said door.

23. The method of claim 22 comprising detecting fall of the signal from the doorway sensor before rise of the signal from the inside sensor, before issuing the door close and/or the door lock signal.

24. The method of claim 23 comprising issuing the door close signal if a predefined time interval has lapsed between the fall of the signal from the doorway sensor and the rise of the signal from the inside sensor and/or issuing only a door close signal if the predefined time interval did not lapse between the fall of the signal from the doorway sensor and the rise of the signal from the inside sensor, for closing the door without locking it.

25. (canceled)

26. The method of any one of claims 22 to 24 comprising issuing an occupied indication after issuing the door close and/or door lock signals; and/or receiving signal from the doorway sensor indicative that the door is in the closed state before generating the occupied indication.

27. (canceled)

28. The method of any one of claims 26 or 27 comprising receiving signal from the inside sensor after the occupied indication is generated, and responsively issuing a door open signal for changing the door into the open state, and stopping generation of the occupied indication.

29. The method of any one of claims 22 to 28 comprising receiving signal from an outside sensor indicative of presence of an individual in an outside space with respect to said door and issuing a door open signal if an occupied indication is not being generated and/or receiving signal from the doorway sensor indicative that the door is in the closed state before issuing the door open signal.

30. (canceled)
